(19) United States
(12) Patent Application Publication
(10) Pub. No.: US 2010/0300162 A1
(43) Pub. Date: Dec. 2, 2010

(54) Remote control cam locking system

(76) Inventors: Louis W. Cappuccio, Hammonton, NJ (US); Luke J. Coia, Hammonton, NJ (US)

Correspondence Address: Hollstein Keating Cattell Johnson & Goldstein P.C., Willow Ridge Executive Office Park, 750 Rt.73S., Suite 301, Marlton, NJ, 08053, US

(21) Appl. No.: 12/455,334

(22) Filed: Jun. 1, 2009

(51) Int. Cl. E05B 65/06

(52) U.S. Cl. 70/257

(57) ABSTRACT

A remote control locking system employs a remote transmitter which sends a signal to a message control module/signal receiver. This signal is ultimately forwarded to a cam control unit which positions a cam member to lock and unlock a door, using an internal latching system. The cam control unit has a motor which, through appropriate gear mechanism, rotates a drive shaft to control the position of the cam member for locking and unlocking the door. The message control module/receiver, cam control unit, and attendant components can be self-contained units, each unit configured for use on individual cam controlled doors. The system can be installed as original equipment on vehicles, but also is readily adaptable to retrofitting existing vehicles which do not have remote locking capability. The system is most beneficially provided for use on trucks and similar work vehicles with multiple compartments and their respective doors, which need to be locked and locked quickly to protect property within the compartments.

### BACKGROUND OF THE INVENTION

Remote vehicle locking systems are well known and various such systems are currently in use at this time. However, many of the systems consist of multiple, complex, components which are integrated into their respective vehicles. As a result, these systems represent expensive options, especially when purchased from the vehicle manufacturer. Moreover, the systems are generally designed to lock and unlock passenger doors on vehicles. They are usually not adapted for commercial vehicle security. Significantly, there are no commercially, economically installed, viable systems which are operable on work trucks having a plurality of storage compartments. It is important that such storage compartments be locked, especially at jobsites, to protect their contents from theft. Valuable tools and other property are often stolen, when one or more compartment doors are inadvertently left unlocked. In addition, given that some trucks have many compartments, each with lockable compartment doors, it is sometimes impractical and often inconvenient to manually lock all doors or use separate remotes to lock individual doors. As to those trucks which do not have remote locks, there is currently no practical means to retro-fit these vehicles so that their multiple compartment doors can be quickly, easily and remotely locked.

### SUMMARY OF THE INVENTION

It is the object of the present invention to provide a remote control cam locking system which overcomes the limitations and disadvantages of previous remote locking systems.

It is an object of the present invention to provide a remote control cam locking system which will lock and unlock one or multiple compartments in the same vehicle.

It is another object of the present invention to provide a remote control cam locking system which has relatively few working components and so is easily and economically manufactured.

It is a further object of the present invention to provide a remote control cam locking system which can be installed both as original equipment on vehicles and as a retrofit on existing vehicles which do not have a remote control locking capability.

It is another object of the present invention to provide a remote control cam locking system which can readily and easily lock and unlock the doors of multiple compartments in a vehicle with the touch of a single button on one remote control.

These and other objects are accomplished by the present invention, a remote control locking system which employs a remote transmitter to send a signal to a message control module/signal receiver. This signal is ultimately forwarded to a cam control unit which positions a cam member to lock and unlock a door, using an internal latching system. The cam control unit has a motor which, through appropriate gear mechanism, rotates a drive shaft to control the position of the cam member for locking and unlocking the door. The message control module/receiver, cam control unit, and attendant components can be self-contained units, each unit configured for use on individual cam controlled doors. The system can be installed as original equipment on vehicles, but also is readily adaptable to retrofitting existing vehicles which do not have remote locking capability. The system is most beneficially provided for use on trucks and similar work vehicles with multiple compartments and their respective doors, which need to be locked and locked quickly to protect property within the compartments.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a section of the outside of a door and handle assembly which employs the cam locking system of the present invention.

FIG. 2 is a section of the inside of a door and the inside of the handle assembly and cam locking system of the present invention.

FIG. 3 is an exploded view of the cam control unit of the cam locking system of the present invention.

FIG. 4 is a schematic representation of the cam locking system of the present invention.

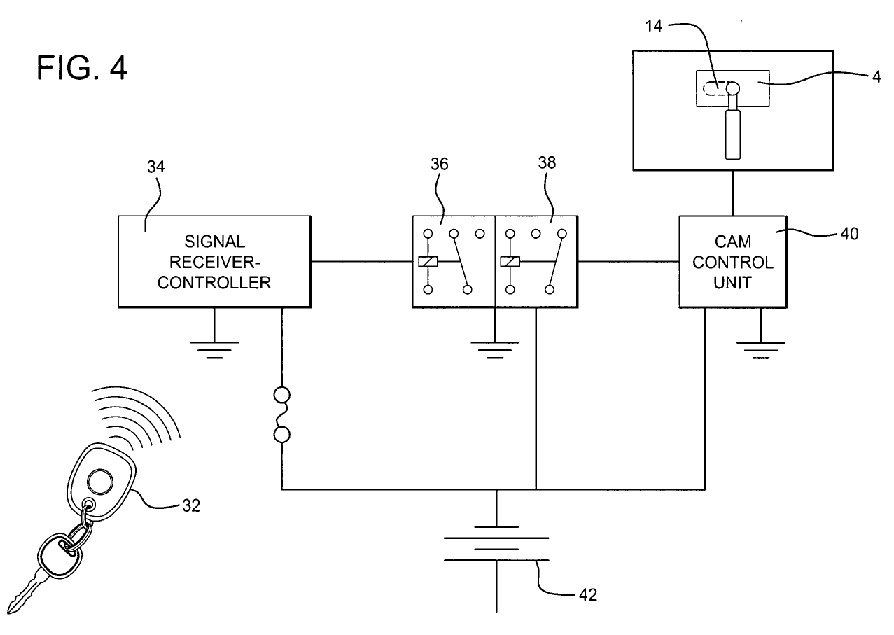

### DETAILED DESCRIPTION OF THE INVENTION

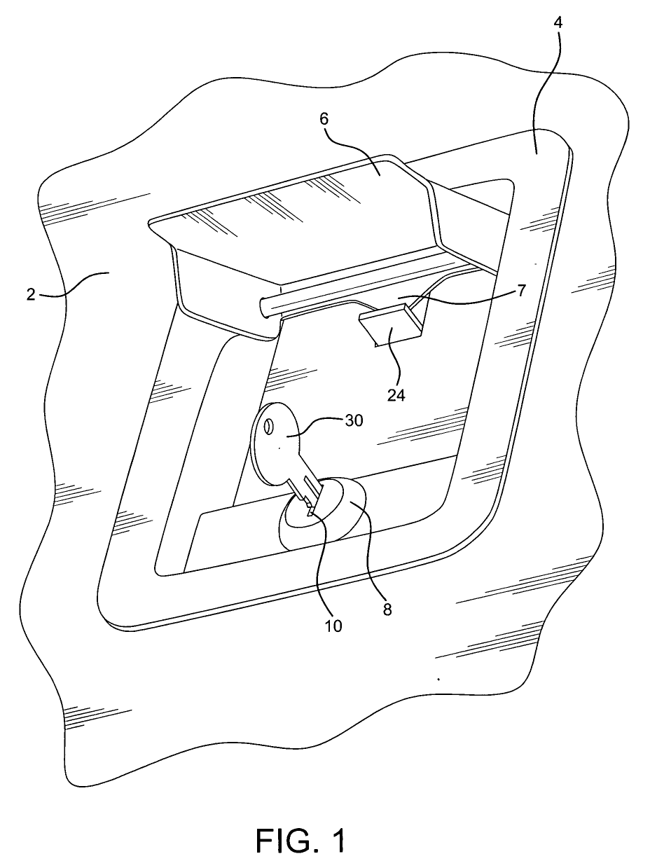

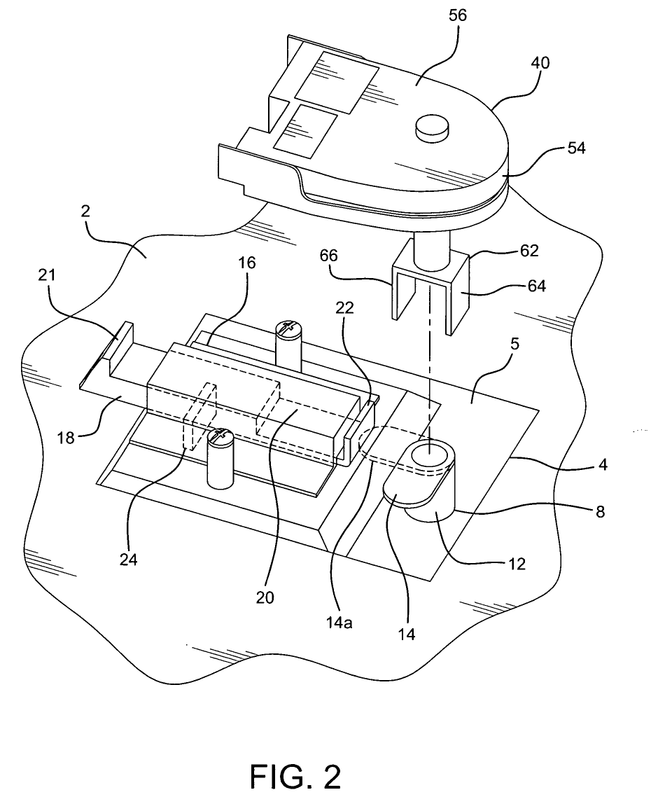

As seen in FIG. 1, vehicle door 2 comprises handle assembly 4 with spring biased handle 6, pivotable outward, away from the door for opening the door. Lock mechanism 8 with keyway 10 extends through handle assembly 4. FIG. 2 shows a section of the inside of door 2 and inboard side 5 of handle assembly 4. Locking mechanism 8 additionally comprises cam support 12 located on inboard side 5 of handle assembly 4. Cam 14 is mounted on cam support 12. Latch assembly 16 of handle assembly 4, also located on inboard side 5, comprises latch arm 18 slideable within cover 20. Latch connection element 21 is located at one end of arm 18. Latch connection element 21 holds door 2 closed, by corresponding door latch receiving component, not shown or a part of the herein invention. Stop element 22 is located at the other end of latch arm 18. The position of latch arm 18 within cover 20 is controlled by handle 6, which is operably connected to the arm by through arm tab 24 (FIG. 1). Pulling handle 6 outward causes its internal tab 7 to pivot upward, lifting arm tab 24. This causes latch arm 18 to slide within cover 20, towards cam support 12. Latch connection element 21 is also contemporaneously raised, allowing the door to open. Releasing handle 6, which is spring biased, compels it to move inward toward door 2. This allows arm tab 24, latch arm 18, and latch connection element 21 to slide within cover 20, away from cam support 12. The door is then again latched closed.

Locking of door 2 is determined by the position of cam 14. With door 2 latched closed, and arm 18 slid down within cover 20, stop element 22 is in its lowered position, just over the cover. By positioning cam 14 perpendicular or adjacent to stop element 22, as shown in ghost depiction 14a in FIG. 2, i.e. lock 8 being in its door lock position, handle 4 is restricted from moving outward since latch arm 18 can not move within cover 20. Door 2 is thus locked. By positioning cam 14 parallel to or away from stop element 22, as shown in full depiction 14 in FIG. 2, i.e. lock 8 being in its unlocked position, latch arm 18 is free to slide upward, so handle 4 is free to move outward allowing door 2 to open.

The cam locking system as described, can be locked and unlocked in situ, using key 30, by manual insertion of the key into lock 8 and rotating cam 14 to its locked and unlocked positions. However, the system is specifically designed for remote operation. A commonly used remote transmitter 32 is used to send a signal to message control module/signal receiver 34, which in turn forwards the appropriate directional signals to relays 36 and 38. The relays energize cam control unit 40, which serves to rotate cam 14 in two directions, from lock to unlock to lock positions. Signals from relay 36 serve to rotate cam 14 clockwise and signals from relay 38 rotate the cam counterclockwise. As described previously, the different positions of cam 14, as seen in FIG. 2, dictate whether door 2 is locked or unlocked. Battery 42, which may be the 12 volt vehicle battery, provides the electricity to power module receiver 34, relays 36 and 38, and cam control unit 40.

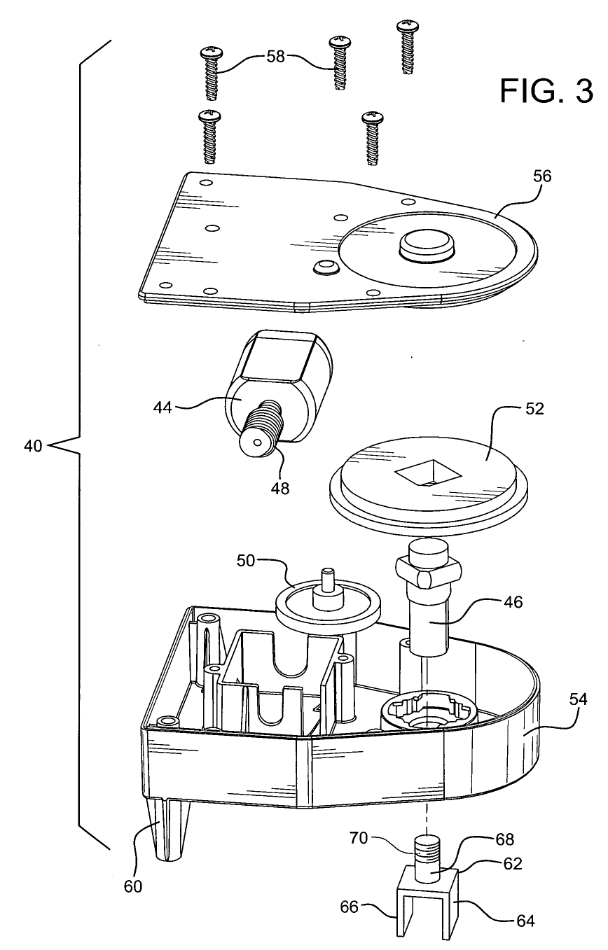

Cam control unit 40, shown in detail in FIG. 3, comprises motor 44, which is provided electrical current by battery 42. Motor 44 rotates drive shaft 46, through worm gear 48, drive gear 50, and main rotating gear 52. All of these components are located within housing 54, through which drive shaft 46 extends. Housing top plate 56 encloses housing 54 by means of screws 58. Mounting supports 60 are provided for attaching cam control unit 40 to door 2, directly over inboard side 5 of handle assembly 4.

Drive shaft 46 is connected to cam 14 by u-shaped connector element 62. Element 62 comprises leg members 64 and 66 at one end which straddle cam 14 and they are connected to the cam by tack welding or equivalent means. The other end of element 62 has attachment section 68, threadably connected at 70 to drive shaft 46.

Thus, when the lock or unlock signal is sent from remote transmitter 32, the appropriate signals are received and transmitted by means of the receiver/relay system described herein. Motor 44 is powered and drives gearing 48, 50, and 52, to rotate drive shaft 46. Connector element 62 in turn rotates cam in the designated directions, either adjacent to stop element 22 to the door lock position, or away from the stop element to the door unlock position.

The cam locking system of the present invention can advantageously be employed on multiple door locks on a single vehicle. For instance, many work trucks have a number of different compartments, each with their own door, handle and lock. With one press of a button on the remote transmitter, all door compartments can be locked and unlocked, thereby ensuring for the safety of valuable tools and other property within the compartments. To accomplish this, a cam control unit 40, connector element 62, cam 14, and cam support 12 would simply be installed as a unit directly over each handle assembly 4, inside each compartment door. This installation could come as original equipment from the vehicle manufacturer, or be retro-fitted on doors of existing vehicles. Mounting supports 60 are configured to easily mount cam control unit 40 on such vehicles. Moreover, the various electrical components of the system and wiring can easily be run through the vehicle and the vehicle's battery can supply the periodic, minimal electric current required.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A remote control cam locking system for a vehicle door comprising:
a lockable door;
a door handle with latching means for controlling the opening and closing of the door, said latching means comprising a slideable arm with a stop element;
locking means extending through the door for remote and in situ locking of the door, said locking means comprising a rotatable cam and cam mounting means for rotatably supporting the cam;
remote transmitter means for sending signals to remotely lock and unlock the door;
control means for receiving the signals from the remote transmitter means;
relay means responsive to signals from the control means for energizing a cam control unit, said cam control unit comprising a housing in which is mounted a drive shaft, a motor, and gear means driven by the motor for rotating the shaft;
connection means mounted at one end of the drive shaft and at its other end to the cam; and
electrical means to power the control means, relay means, and the motor within the cam control unit, whereby sending a signal from the remote transmitter means, energizes the motor, causing the shaft to rotate the cam to a position adjacent to the stop element to immobilize the arm and lock the door and to rotate the cam to a position away from the stop element to allow slideable movement of the arm to unlock the door.

2. The remote control cam locking system as in claim 1 wherein the relay means comprises two relays, one relay configured to rotate the drive shaft of the cam control unit in one direction and the other relay configured to rotate the drive shaft of the cam control unit in the opposite direction, whereby when the drive shaft rotates in the first direction the door is locked and when it rotates in the second direction the door is unlocked.

3. The remote control cam locking system as in claim 1 wherein the cam is positioned substantially perpendicular to the stop element to lock the door and is positioned substantially parallel to the stop element when the door is unlocked.

4. The remote control cam locking system as in claim 1 wherein the connection means comprises a unshaped element with its first end connected to the drive shaft and its second end having legs which straddle the cam and cam mounting means.

5. The remote control cam locking system as in claim 1 wherein the locking means further comprises a keyway for in situ locking and unlocking of the door.

6. A remote control cam locking system for a vehicle door comprising:
a lockable door;
a door handle with latching means for controlling the opening and closing of the door, said latching means comprising a stop element;
locking means extending through the door for remote and in situ locking of the door, said locking means comprising a rotatable cam and cam mounting means for rotatably supporting the cam;
remote transmitter means for sending signals to remotely lock and unlock the door;
control means for receiving the signals from the remote transmitter means;
a cam control unit comprising a drive shaft and motive means for rotating the shaft;
connection means mounted between the drive shaft and the cam; and
electrical means to power the control means and the motive means within the cam control unit, whereby sending a signal from the remote transmitter causes the shaft to rotate the cam to a position adjacent to the stop element to lock the door and to rotate the cam to a position away from the stop element to unlock the door.

7. The remote control cam locking system as in claim, 6 further comprising relay means responsive to signals from the control means for energizing the cam control unit.

8. The remote control cam locking system as in claim 7 wherein the relay means comprises two relays, one relay configured to rotate the drive shaft of the cam control unit in one direction and the other relay configured to rotate the drive shaft of the cam control unit in the opposite direction, whereby when the drive shaft rotates in the first direction the door is locked and when it rotates in the second direction the door is unlocked.

9. The remote control cam locking system as in claim 6 wherein the cam is positioned substantially perpendicular to the stop element to lock the door and is positioned substantially parallel to the stop element when the door is unlocked.

10. The remote control cam locking system as in claim 6 wherein the connection means comprises a unshaped element with its first end connected to the drive shaft and its second end having legs which straddle the cam and cam mounting means.

11. The remote control cam locking system as in claim 6 wherein the locking means further comprises a keyway for in situ locking and unlocking of the door.

12. The remote control cam locking system as in claim 6 wherein the motive means comprises an electric motor.
